(19) United States
(12) Patent Application Publication
(10) Pub. No.: US 2016/0347597 A1
(43) Pub. Date: Dec. 1, 2016

(54) BEVERAGE TRANSPORT AND DISPENSING CART

(71) Applicant: Ronald E. Schlecht, JR., Boyertown, PA (US)

(72) Inventor: Ronald E. Schlecht, JR., Boyertown, PA (US)

(21) Appl. No.: 15/168,982

(22) Filed: May 31, 2016

Related U.S. Application Data
(60) Provisional application No. 62/168,354, filed on May 29, 2015.

(51) Int. Cl. B67D 1/04; B67D 1/12; B67D 1/08

(52) U.S. Cl. CPC B67D 1/0412; B67D 1/0801; B67D 1/0857; B67D 1/0891; B67D 1/1277; B67D 2001/0822

(57) ABSTRACT

A device for beer keg transportation, cooling beer quickly, and dispensing it easily. The dispensing cart combines a handcart for transport of the keg, a heat exchanger for cooling the beer contained in the keg, and a bracket to contain a pressurized gas cylinder for charging the keg.

### CROSS-REFERENCE TO RELATED APPLICATION

This application claims the benefit of priority of U.S. provisional application No. 62/168,354, filed May 29, 2015 the contents of which are herein incorporated by reference.

### BACKGROUND OF THE INVENTION

The present invention relates beverage transport and dispensing apparatus, and more particularly to an apparatus for transporting, chilling, and dispensing a beverage contained in a bulk storage barrel.

Currently, there exist dispensing carts for beer and other beverages contained in barrel, however these carts are primarily designed for retail type establishments, or formal environments. Such carts are difficult to be moved over uneven terrain without great effort and their cost makes them prohibitive for most consumers.

As can be seen, there is a need for an apparatus for conveniently transporting across uneven terrain, quickly chilling, and dispensing beverages from a bulk storage barrel.

### SUMMARY OF THE INVENTION

In one aspect of the present invention, a beverage dispensing cart includes a support platform adapted to support a vessel containing the beverage. The cart has at least one upright member having a first end attached to the support platform and a handle extending from a second end of the at least one upright member; a heat exchanger attached to the at least one upright member, the heat exchanger having an inlet adapted to be coupled to an outlet of the vessel; and a dispensing valve operatively coupled to an outlet of the heat exchanger.

In other embodiments the cart includes a plurality of ground transport wheels operatively attached to a base portion of the cart. The heat exchanger further includes an insulated container having at least one sidewall defining a cavity therein. The heat exchanger may also include a coiled tube contained within the cavity, the coiled tube having an inlet and an outlet, the inlet extending through the sidewall and terminating in a shank, the outlet operatively coupled to the dispensing valve. The cart may also have a cylinder bracket adapted to receive a cylinder containing a pressurized gas. The ground transport wheels are selectively position able between a transport condition and a stowed condition.

In other aspects of the invention, a beverage dispensing cart, has a support platform adapted to support a vessel containing the beverage; at least one upright member having a first end attached to the support platform and a handle extending from a second end of the at least one upright member; a cylinder bracket adapted to receive a cylinder containing a pressurized gas; a dispensing valve having an inlet and an outlet: and a delivery tube in fluid communication with the dispensing valve inlet and adapted to be connected to an outlet of the vessel. The cart may also be configured with a heat exchanger means operatively coupled between the dispensing valve and the delivery tube. The heat exchanger means may include an insulated container having at least one sidewall defining a cavity therein. The heat exchanger means may also include a coiled tube contained within the cavity, the coiled tube having an inlet and an outlet, the inlet extending through the sidewall and terminating in a shank, and the outlet operatively coupled to the dispensing valve. The coiled tube may be formed of a metallic material. IN preferred embodiments, the cart is equipped with a plurality of ground transport wheels operatively attached to a base portion of the cart. The ground transport wheels are operable between a transport position and a stowed position.

In yet other aspects of the invention a beverage dispensing hand cart, includes a hand cart having a support platform adapted to support a barrel containing the beverage, the hand cart having at least one upright member having a first end attached to the support platform and a handle extending from a second end of the at least one upright member, a plurality of ground transport wheels operatively attached to a base portion of the cart; a cylinder bracket adapted to receive a cylinder containing a pressurized gas; a dispensing valve having an inlet and an outlet: a delivery tube in fluid communication with the dispensing valve inlet and adapted to be connected to an outlet of the barrel; and a heat exchanger means operatively coupled between the dispensing valve inlet and the delivery tube. The heat exchanger means may included an insulated container having at least one sidewall defining a cavity therein; and a coiled tube contained within the cavity, the coiled tube having an inlet and an outlet, the inlet extending through the sidewall and terminating in a shank, and the outlet operatively coupled to the dispensing valve.

### BRIEF DESCRIPTION OF THE DRAWINGS

FIG. 1 is a front perspective view of an embodiment of a beverage transport and dispensing cart of the present invention.

FIG. 2 is a rear perspective view of the cart.

FIG. 3 is a front perspective view of the cart shown in open configuration and shown without ice for illustrative clarity.

FIG. 4 is a section detail view of the cart taken along line 4-4 in FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a transport and dispensing apparatus for serving beverages contained in a bulk storage vessel. More preferably, the beverage is dispensed in a chilled condition

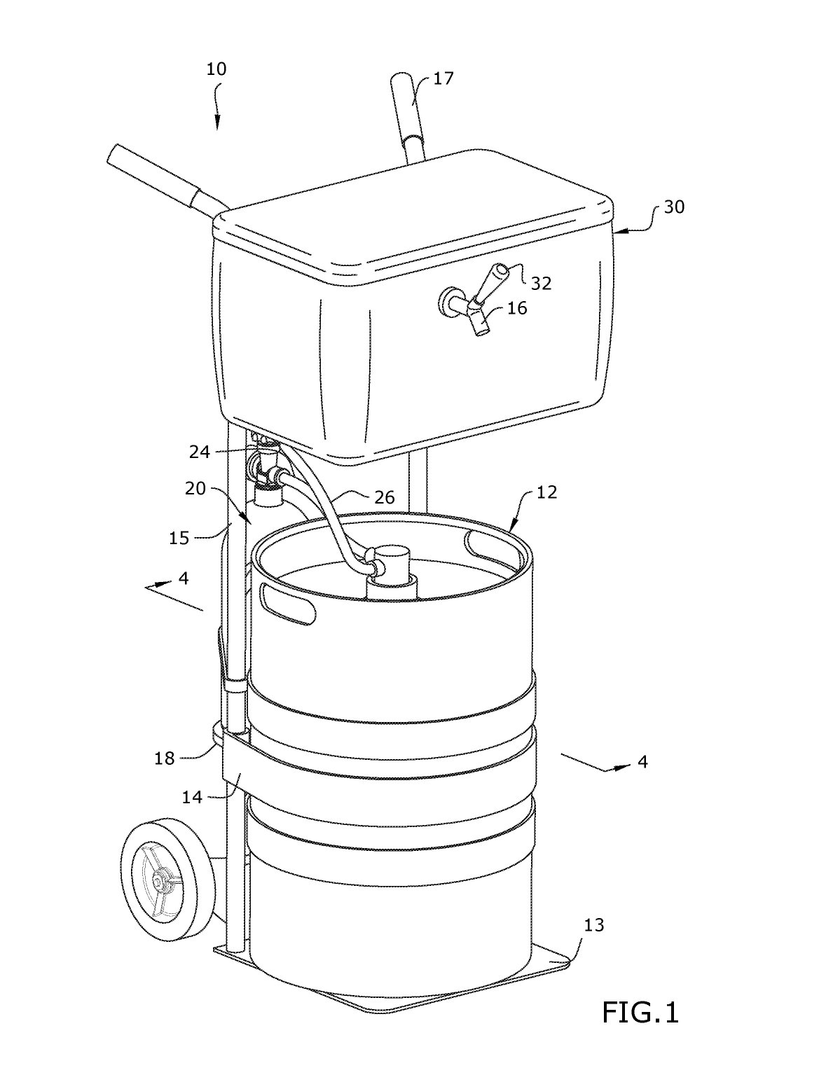

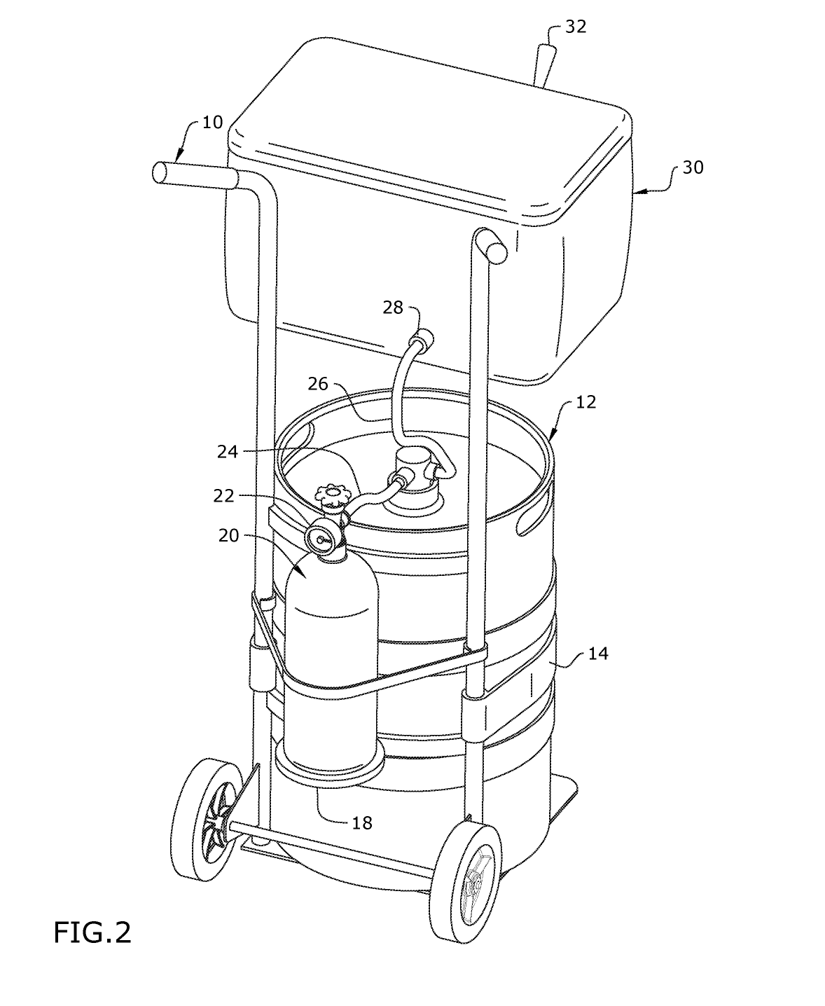

As seen in reference to FIGS. 1 and 2, the beverage transport and dispensing apparatus of the present invention includes a cart 10 adapted to carry a beverage containment barrel 12, such as a keg of beer. The cart 10 is configured with a support plate 11 extending forwardly from a lower portion of the cart 10 to support the barrel 12. The barrel 12 is secured to the cart 10 via a clamp 14, which may include a metallic band camp, nylon or woven fabric strap, a clamp that engages the rim of the barrel 12.

The cart 10 is provided with a plurality of ground transport wheels 13 for supporting the cart during transport conditions. The ground transport wheels 13 may be continuously engaged with a ground surface to support the cart 10 or they may be configured to selectively engage the ground during transport and disengaged from the ground during beverage dispensing or storage operations.

At least one upright member 15 has a first end operatively attached to the lower portion of the cart 10 extends upwardly to a second end proximal to an upper portion of the cart 10. A handle 17 is defined at the second end of the support member 15. The handle 17 is configured to provide a gripping location for an operator to manipulate and position the cart 10 via the ground transport wheels 13. The from

The cart 10 may further include a dispensing valve 16, or tap, operatively connected to the barrel 12 via tubing 26. The tap 16 further includes a handle 32 to operate the tap 16 between a closed position and an open, fluid dispensing condition. For dispensing beverages, such as beer, it is often desirable to dispense the beverage in a chilled condition. According to some embodiments of the invention, the cart 10 may further include a cooling apparatus interposed between the beverage barrel 12 and the dispensing tap 16.

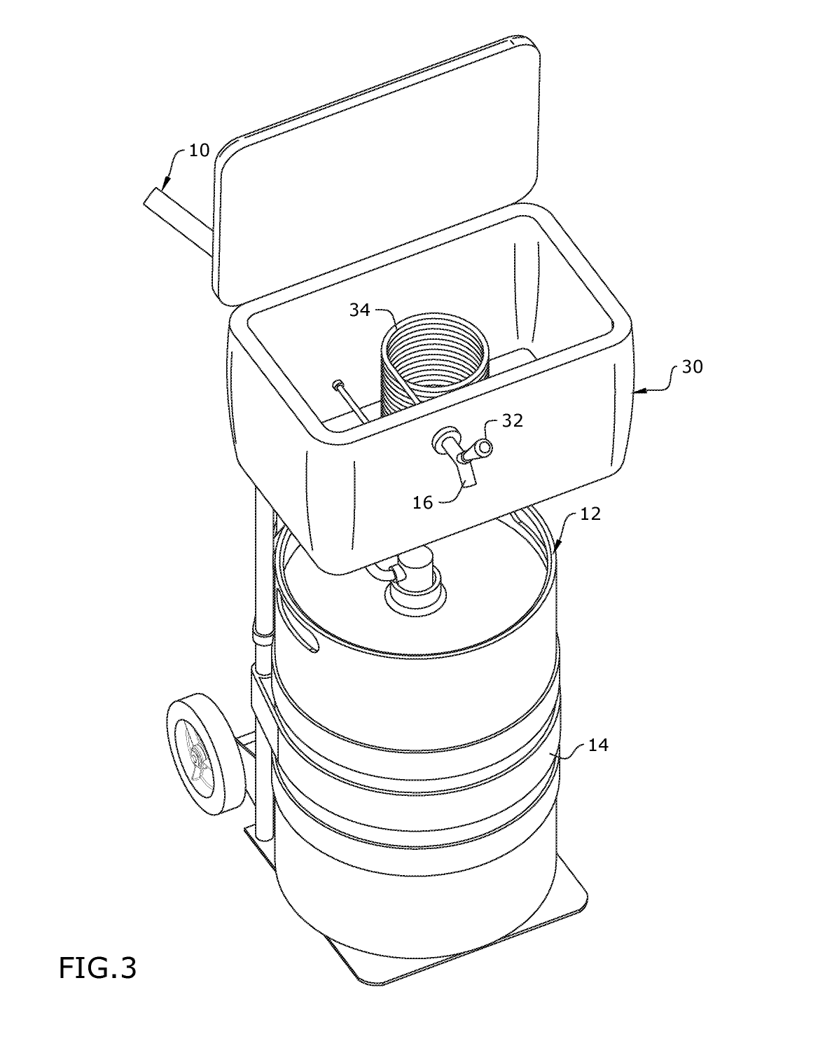

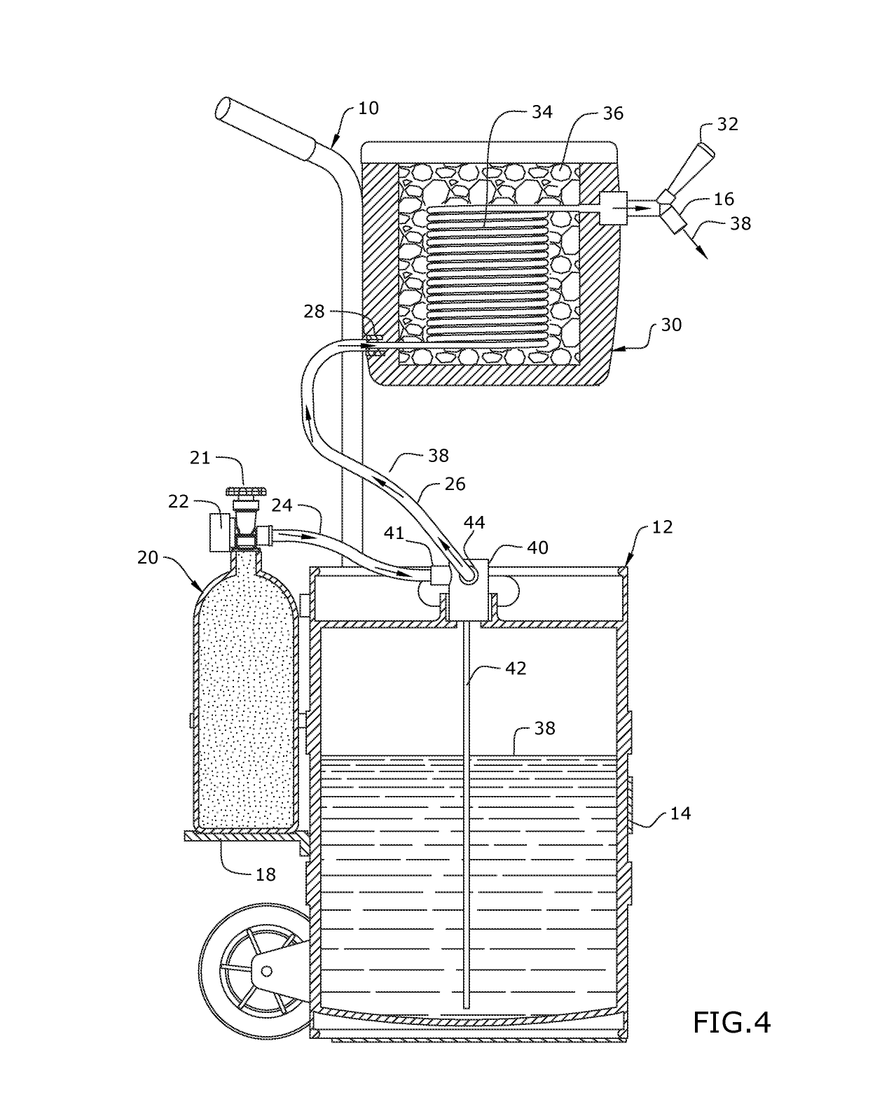

As seen in reference to FIGS. 3 and 4, the cart 10 may further include a cooling apparatus configured to chill the liquid beverage as it is dispensed. In a preferred embodiment the cooling apparatus may include an insulated container 30 having at least one sidewall defining an interior cavity. A heat exchanger 34 may be contained within the interior cavity of the insulated container 30 and interposed between the tubing 26 and the tap 16.

Preferably, the heat exchanger 34 is formed as a coiled tube in fluid communication with the tubing 26 and the tap 16. More preferably the heat exchanger 34 is formed from a coil of thermally conductive material, such as a metal. By way of example, depending on the inner diameter of the tubing, the coil may be formed from a length of tubing having a linear length of about 50 ft. The selected metal should be of a food and beverage grade material and be compatible with beverages being dispensed, such as stainless steel, or copper. A coupling shank 28 is configured to extend a first end of the coil 34 through the side wall of the insulated container 30 and a second end of the coil 34 is operatively coupled to an inlet of the tap 16. The tap 16 may be attached to the sidewall of the insulated container 30.

The interior cavity of the insulated container 30 may be cooled by any suitable means. In a preferred embodiment, the interior cavity is adapted to receive a quantity of ice 36, which may be water in a frozen condition, dry ice, reusable cold pack materials. More preferably the ice 36 is provided as an ice bath that may surround and chill the heat exchanger 34.

As will be appreciated by those of skill in the art, the beverage vessel 12 requires a source of pressure to be conveyed to the beverage contents 38 within the vessel 12 in order to convey the liquid 38 out of the vessel 12 for delivery to the tap 16. The pressure source may be a hand pump, operatively coupled to an inlet of a barrel fitting 40 disposed at the top of the barrel 12. Alternatively, the pressure source may be provided via a pressurized gas delivered to the barrel interior via the inlet 41 at fitting 40. In further reference to FIG. 4, pressurized, liquids 38 within the barrel are conveyed through a delivery tube 42 extending between an outlet 44 of the fitting 40 and a bottom of the barrel 12

In a preferred embodiment, the cart 10 of the present invention is configured with a mounting bracket 18, adapted to receive a pressurized gas cylinder 20. The pressurized gas cylinder 20 may be charged with, for example CO₂, or any suitable beverage dispensing gas. The cylinder 20 is operatively connected to the inlet at fitting 40. The cylinder may include a valve 21 for controlling the pressure and delivery of the gas to pressurize the liquid beverage 38 contained within the barrel 12. A the cylinder 20 may also include a pressure gauge 22 to permit the operator to set a desired delivery pressure of the gas to the barrel 12 by adjustment of the valve 21.

In further reference to FIG. 4, in order to dispense a liquid beverage 38 from the barrel 12, the operator would configure the pressurized gas in communication with the fitting inlet 41, open valve 21 and set a desired delivery pressure by viewing gage 22. With the tubing 26 connected to the barrel 12 and the heat exchanger shank 28, the operator would manipulate handle 32 so that the liquid beverage 38 is conveyed through the barrel tube 42, tubing 26, the heat exchanger 34 and is dispensed from the tap 16.

It should be understood, of course, that the foregoing relates to exemplary embodiments of the invention and that modifications may be made without departing from the spirit and scope of the invention as set forth in the following claims.

What is claimed is:

1. A beverage dispensing cart, comprising:
a support platform adapted to support a vessel containing the beverage;
at least one upright member having a first end attached to the support platform and a handle extending from a second end of the at least one upright member;
a heat exchanger attached to the at least one upright member, the heat exchanger having an inlet adapted to be coupled to an outlet of the vessel;
a dispensing valve operatively coupled to an outlet of the heat exchanger; and
a plurality of ground transport wheels operatively attached to a base portion of the cart.

2. The cart of claim 1, wherein the heat exchanger further comprises:
an insulated container having at least one sidewall defining a cavity therein.

3. The cart of claim 2, wherein the heat exchanger further comprises:
a coiled tube contained within the cavity, the coiled tube having an inlet and an outlet, the inlet extending through the sidewall and terminating in a shank, the outlet operatively coupled to the dispensing valve.

4. The cart of claim 3, further comprising:
a cylinder bracket adapted to receive a cylinder containing a pressurized gas.

5. The cart of claim 1, wherein the ground transport wheels are selectively positionable between a transport condition and a stowed condition.

6. A beverage dispensing cart, comprising:
a support platform adapted to support a vessel containing the beverage;
at least one upright member having a first end attached to the support platform and a handle extending from a second end of the at least one upright member;
a cylinder bracket adapted to receive a cylinder containing a pressurized gas;
a dispensing valve having an inlet and an outlet;
a delivery tube in fluid communication with the dispensing valve inlet and adapted to be connected to an outlet of the vessel; and
a plurality of ground transport wheels.

7. The cart of claim 6, further comprising:
heat exchanger means operatively coupled between the dispensing valve and the delivery tube.

8. The cart of claim 7, wherein the heat exchanger means comprises:
an insulated container having at least one sidewall defining a cavity therein.

9. The cart of claim 8, wherein the heat exchanger means further comprises:
a coiled tube contained within the cavity, the coiled tube having an inlet and an outlet, the inlet extending through the sidewall and terminating in a shank, and the outlet operatively coupled to the dispensing valve.

10. The cart of claim 8, wherein the coiled tube is formed of a metallic material.

11. The cart of claim 10, wherein the plurality of ground transport wheels are operable between a transport position and a stowed position.

12. A beverage dispensing hand cart, comprising:
a hand cart having a support platform adapted to support a barrel containing the beverage, the hand cart having at least one upright member having a first end attached to the support platform and a handle extending from a second end of the at least one upright member, a plurality of ground transport wheels operatively attached to a base portion of the cart;
a cylinder bracket adapted to receive a cylinder containing a pressurized gas;
a dispensing valve having an inlet and an outlet:
a delivery tube in fluid communication with the dispensing valve inlet and adapted to be connected to an outlet of the barrel; and
a heat exchanger means operatively coupled between the dispensing valve inlet and the delivery tube.

13. The hand cart of claim 12, wherein the heat exchanger means comprises:
an insulated container having at least one sidewall defining a cavity therein; and
a coiled tube contained within the cavity, the coiled tube having an inlet and an outlet, the inlet extending through the sidewall and terminating in a shank, and the outlet operatively coupled to the dispensing valve.
